(19) United States
(12) Patent Application Publication
(10) Pub. No.: US 2007/0048618 A1
(43) Pub. Date: Mar. 1, 2007

(54) Electrochemical devices

(76) Inventors: Takefumi Okumura, Hitachinaka (JP); Masanori Sakai, Hitachiota (JP); Akira Satou, Hitachiomiya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/505,306

(22) Filed: Aug. 17, 2006

(30) Foreign Application Priority Data
Aug. 25, 2005 (JP) 2005-244659

(51) Int. Cl. H01M 10/40; H01M 2/16

(52) U.S. Cl. 429/309; 429/246

(57) ABSTRACT

This invention provides electrochemical devices that facilitate formation of an electric double layer, i.e., a reaction field at the electrode interface, for the purpose of reducing interface resistance. Such electrochemical devices each independently have a positive electrode and a negative electrode, wherein the positive electrode and the negative electrode are each in contact with a polymer, and wherein the Lewis acid properties of a polymer that is in contact with the positive electrode are different from those of a polymer that is in contact with the negative electrode.

### BACKGROUND OF THE INVENTION

1. Field of the Invention

The present invention relates to electrochemical devices such as Li secondary batteries, electric double layer capacitors, and dye sensitized solar cells.

2. Description of Related Art

Up to the present, liquid electrolytes have been used in electrochemical devices such as batteries, capacitors, and solar cells, because of their high ionic conductivity. However, liquid electrolytes have been problematic in terms of, for example, the possibility of damage to equipment due to fluid leakage.

In the field of Li secondary batteries, for example, secondary batteries using solid electrolytes, such as inorganic crystalline materials, inorganic glasses, and organic polymers, have been proposed in recent years. Use of such solid electrolytes can result in less fluid leakage of carbonate solvents and less likelihood of electrolyte ignition than in cases where conventional liquid electrolytes using carbonate solvents are used. This results in enhanced device reliability and safety. In general, organic polymers have excellent processibility and moldability, electrolytes obtained therefrom have flexibility and bending workability, and the degree of freedom in designing devices to which solid electrolytes are to be applied can be increased. Thus, development thereof has been expected. When solid electrolytes are employed, however, the contact at the electrolyte/electrode boundary is inferior to the contact when liquid electrolytes are employed. Thus, active materials in the electrodes are coated with solid electrolytes in advance to improve the contact (e.g., JP Patent Publication (Unexamined) No. 11-7942 (1999)).

JP Patent Publication (Unexamined) No. 2004-171907 discloses a Li secondary battery comprising a positive electrode active material and a polycation, which is a polymer having a functional group acting as a Lewis base, and a polyanion, which is a polymer having a functional group acting as a Lewis acid, provided on the active material.

### SUMMARY OF THE INVENTION

The solid electrolytes comprising organic polymers as described above have lower ion intensity, and an electric double layer, which constitutes a reaction field at the electrode interface, is less likely to be formed, compared with the case of liquid electrolytes. Accordingly, interface resistance is high and cell reaction is less likely to advance, even when the active materials in the electrodes are coated with solid electrolytes in advance with a view to improving the contact.

The present invention is directed to providing electrochemical devices that facilitate formation of an electric double layer, i.e., a reaction field at the electrode interface, for the purpose of reducing interface resistance.

The present invention provides electrochemical devices each independently having a positive electrode and a negative electrode, in which the positive electrode and the negative electrode are each in contact with a polymer, and in which the Lewis acid properties of the polymer that is in contact with the positive electrode are different from those of the polymer that is in contact with the negative electrode.

### BRIEF DESCRIPTION OF THE DRAWING

FIG. 1 shows an enlarged cross-sectional view of electrodes of a Li secondary battery.

### PREFERRED EMBODIMENTS OF THE INVENTION

A preferable embodiment of the present invention provides electrochemical devices each independently having a positive electrode and a negative electrode, wherein separate polymers having different Lewis acid properties are used for the positive electrode and for the negative electrode. More specifically, such polymers having different Lewis acid properties are: a polycation, which is a polymer having a functional group that acts as a Lewis acid at a negative electrode; and a polyanion, which is a polymer having a functional group that acts as a Lewis base at a positive electrode. A polyanion having —COOR (R=H, an alkyl group) and/or —SO₃H and a polycation having —NHR (R=H, an alkyl group) are particularly preferable. Such alkyl group preferably has 1 to 5 carbon atoms.

Another embodiment of the present invention provides electrochemical devices each independently having a positive electrode and a negative electrode, wherein the surfaces of a positive electrode active material and of a negative electrode active material are coated with polymers, and the Lewis acid properties of the polymer that coats the positive electrode active material differ from those of the polymer that coats the negative electrode active material. Preferably, a polymer that coats the negative electrode active material is a polycation, which is a polymer having a functional group that acts as a Lewis acid, and a polymer that coats the positive electrode active material is a polyanion, which is a polymer having a functional group that acts as a Lewis base. Preferably, the polyanion is a polymer having —COOR (R=H, an alkyl group) and/or —SO₃H and the polycation is a polymer having —NHR (R=H, an alkyl group).

Hereafter, Li secondary batteries are particularly specifically described, among the electrochemical devices according to the present invention. It should be noted that the present invention is applicable to not only Li secondary batteries but also to electrochemical devices such as capacitors or solar cells.

The Li secondary battery according to an embodiment of the present invention comprises a positive electrode having compound oxide comprising lithium and a transition metal as positive electrode active materials, a negative electrode comprising amorphous carbon and/or graphite as negative electrode active materials, and a polymer electrolyte containing an electrolyte salt. The positive electrode active material and the negative electrode active material are provided with polymer coatings having different Lewis acid properties. The term “coating” used herein refers to the existence of polymers on the surface, and polymers may be scattered or unevenly distributed on active materials. Active materials may be occasionally exposed.

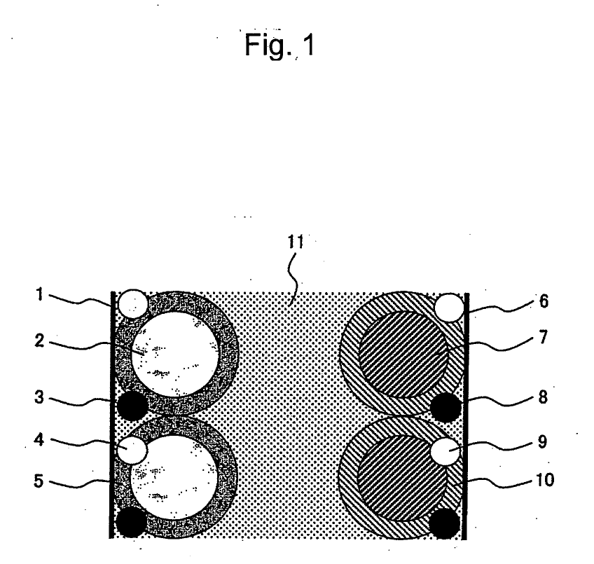

An embodiment of the present invention is described with reference to FIG. 1. FIG. 1 shows an enlarged cross-sectional view of electrodes of a Li secondary battery according to the embodiment of the present invention. The positive electrode of the Li secondary battery is composed of an aluminum (Al) current collector 1 and a mixture of a positive electrode active material 2, a conducting material 3, and a binder polymer 4 provided thereon. The positive electrode active material 2 is coated with a polymer layer 5. In such a case, the polymer layer 5 is a polyanion coating. The negative electrode of the Li secondary battery is composed of a copper (Cu) current collector 6 and a mixture of a negative electrode active material 7, a conducting material 8, and a binder polymer 9 provided thereon. The negative electrode active material 7 is coated with a polymer layer 10. In such a case, the polymer layer 10 is a polycation coating. An electrolyte 11 is present between the positive electrode and the negative electrode.

Active materials 2 and 7 each have a particle diameter of approximately 10 μm. Polymer coatings 4 and 10 each have a membrane thickness of approximately 10 nm. The membrane thickness varies in accordance with the change of particle diameter. Preferably, the membrane thickness is approximately 0.1% of the particle diameter. The thickness of the positive electrode material coated on the current collector is 20 μm to 100 μm. The thickness of the negative electrode material is 20 μm to 100 μm.

A polyanion is a polymer having —COOR (R=H, an alkyl group) and/or —SO₃H. Examples of such polymer include polystyrene sulfonate, a polymer having a sulfone group in its molecule, polyacrylate, and a polymer having a carboxyl or ester group in its molecule.

A polycation is a polymer having —NHR (R=H, an alkyl group). Examples of such polymer include polyaniline, polyvinylamine, a polymer having an amino group, and a derivative of any of such polymers.

Such a polymer can be a copolymer of different monomers. Examples of monomers to be copolymerized include ethylene, propylene, styrene, and ethylene oxide.

The polymer electrolyte of the present invention is composed of an ionic-conductive polymer and an electrolyte salt. Conventional ionic-conductive polymers can be used in the present invention. A representative example of such polymer is polyether comprising an oxyalkylene group. The following electrolyte salts can be preferably used. Specific examples include compounds comprising a metal cation and an anion selected from the group consisting of chlorine, bromine, iodine, perchlorate, thiocyanate, tetrafluoroborate, hexafluorophosphate, trifluoromethane-sulfonidimidate, stearyl sulfonate, octyl sulfonate, dodecylbenzenesulfonate, naphthalenesulfonate, dodecylnaphthalenesulfonate, 7,7,8,8-tetracyano-p-quinodimethane, and lower aliphatic carboxylate. Examples of metal cations include Li, Na, K, Rb, Cs, Mg, Ca, and Ba ions. The concentration of the electrolyte is 0.0001 to 1, and preferably 0.001 to 0.5, in terms of molar ratio ((number of moles of an electrolyte salt)/(total number of moles of an ether oxygen atoms in an oxyalkylene group)), based on the total number of moles of the ether oxygen atoms in an alkyleneoxy group in an ionic-conductive polymer. When such value exceeds 1, processibility, moldability, and mechanical strength of the resulting polymer electrolyte are deteriorated.

In the present invention, a positive electrode active material may be at least one of the following: a layered compound such as a lithium cobalt oxide (LiCoO₂) or lithium nickel oxide (LiNiO₂); a layered compound in which at least one kind of transition metal has been substituted; a lithium manganese oxide (Li₁₊ₓMn₂₋ₓO₄, where x=0 to 0.33); Li₁₊ₓMn_{2-x-y}M_{y}O₄, where M is at least one metal selected from the group consisting of Ni, Co, Cr, Cu, Fe, Al, and Mg, x=0 to 0.33, y=0 to 1.0, and 2−x−y>0; LiMnO₃, LiMn₂O₃, LiMnO₂, or LiMn₂₋ₓMxO₂, where M is at least one metal selected from the group consisting of Co, Ni, Fe, Cr, Zn, and Ta, and x=0.01 to 0.1; Li₂Mn₃MO₈, where M is at least one member selected from the group of metals consisting of Fe, Co, Ni, Cu, and Zn; a copper-lithium oxide (Li₂CuO₂); an oxide of vanadium such as LiV₃O₈, LiFe₃O₄, V₂O₅, or Cu₂V₂O₇; a disulphide compound; and a mixture containing Fe₂(MoO₄)₃, etc.

In the present invention, negative electrode active materials that reversibly intercalate and deintercalate lithium include: natural graphite; an easily graphitizable material obtained from petroleum coke, or coal pitch coke that has been subjected to heat treatment at high temperatures of 2500° C. or higher; mesophase carbon or amorphous carbon; carbon fiber; a metal that alloys with lithium; or carbon particles carrying a metal on the surfaces thereof. Examples thereof include metals or alloys selected from the group consisting of lithium, aluminum, tin, silicon, indium, gallium, and magnesium. These metals or their oxides may be utilized for the negative electrode active materials.

Applications of the lithium ion secondary batteries of the present invention are not particularly limited. For example, such secondary batteries can be used as the electric power supplies for IC cards, personal computers, large-sized electronic calculators, notebook-sized personal computers, pen-based computers, notebook-sized word processors, cellular phones, portable cards, wristwatches, cameras, electric shavers, cordless phones, fax machines, videos, camcorders, electronic personal organizers, desktop calculators, electronic personal organizers with communication tools, portable copy machines, liquid crystal television sets, electric tools, vacuum cleaners, game machines having functions such as virtual reality, toys, electric bicycles, walking-aid machines for healthcare purposes, wheelchairs for healthcare purposes, moving beds for healthcare purposes, escalators, elevators, forklifts, golf buggies, emergency electric supplies, load conditioners, or electric power storage systems. The lithium ion secondary batteries of the present invention can also be used for military or space-exploration purposes, as well as for consumer applications.

Hereafter, the present invention is described in greater detail with reference to the examples and the comparative examples.

### EXAMPLE 1

The following experiment was carried out using polybutyl acrylate and polyaniline as a polyanion and a polycation, respectively.

[Preparation of Coated Active Material and Method for Confirming the Coating]

As a positive electrode active material, 30 parts by weight of Cellseed (lithium cobalt oxide, Nippon Chemical Industries, Co., Ltd.) was dispersed in 70 parts by weight of an acetone solution containing polybutyl acrylate, which is equivalent to 0.2% of the coating polymer. The resulting dispersion was allowed to stand in an organic draft for 6 hours. Thereafter, the positive electrode active material was sedimented in the dispersion, and 40 parts by weight of a supernatant was removed. The remnant was dried at 80° C. for 12 hours, and a positive electrode active material substantially free from aggregation was obtained. This is hereafter referred to as a coated positive electrode active material A.

As a negative electrode active material, 30 parts by weight of Carbotron PE (amorphous carbon, Kureha Chemical Industry Co., Ltd.) was dispersed in 70 parts by weight of an acetone solution containing polyaniline, which is equivalent to 0.2% of the coating polymer. The resulting dispersion was allowed to stand in an organic draft for 6 hours. Thereafter, the negative electrode active material was sedimented in the dispersion, and 40 parts by weight of a supernatant was removed. The remnant was dried at 80° C. for 12 hours, and a negative electrode active material substantially free from aggregation was obtained. This is hereafter referred to as a coated negative electrode active material B.

Measurement of the diffuse reflection infrared absorption spectrum enables the observation of stretching vibrations peculiar to a functional group contained in the polymer. The presence of the polymer coated on the positive electrode active material can be confirmed based thereon. In the present example, the presence of polybutyl acrylate was confirmed by observing the stretching vibrations of carbonyl, and the presence of polyaniline was confirmed by observing the stretching vibrations of amine.

[Method of Preparing Electrodes]

(Positive Electrode)

The coated positive electrode active material A, SP270 (graphite, Nippon Graphite Industries, Ltd.), and KF1120 (polyvinylidene fluoride, Kureha Chemical Industry Co., Ltd.) were mixed with one another at a proportion of 80:10:10 (% by weight), and the mixture was introduced into and mixed with N-methyl-2-pyrrolidone to prepare a slurry solution. The slurry was applied to aluminum foil with a thickness of 20 μm by the doctor blade method, followed by drying. The amount of the mixture applied was 150 g/m². The aluminum foil was pressed to bring the bulk density of the mixture to 3.0 g/cm³ and then cut into 1 cm×1 cm sections to produce positive electrode.

(Negative Electrode)

The coated negative electrode active material B and KF1120 (polyvinylidene fluoride, Kureha Chemical Industry Co., Ltd.) were mixed with each other at a proportion of 90:10 (% by weight), and the mixture was introduced into and mixed with N-methyl-2-pyrrolidone to prepare a slurry solution. The slurry was applied to copper foil with a thickness of 20 μm by the doctor blade method, followed by drying.

[Method for Preparing Batteries]

Polyethylene oxide (number average molecular weight: 600,000, Aldrich) and an electrolyte salt, i.e., LiN(C₂F₅SO₂)₂, were mixed with dimethyl carbonate (solution A) in advance. The concentration of the electrolyte salt was adjusted at 0.125 in terms of molar ratio ((number of moles of an electrolyte salt)/(total number of moles of an ether oxygen atom in an oxyalkylene group)), based on the total number of moles of the ether oxygen atom in an oxyalkylene group in an ionic-conductive polymer. The positive electrode and the negative electrode were coated with the solution, allowed to stand in an argon atmosphere at 80° C. for 12 hours, and then vacuum dried at 80° C. for 12 hours to solidify the polymer electrolyte. A polyethylene separator was inserted between the coated electrodes, and the positive and negative electrodes were then laid one upon the other and were retained at 80° C. for 12 hours under a load of 0.1 MPa to bind them together. Thus, a battery A was prepared.

[Charge/Discharge Conditions of Batteries]

A charge/discharge operation was performed using a charger/discharger (TOSCAT3000, Toyo System Co., Ltd.) at 50° C. with a current density of 0.5 mA/cm². A constant current charge operation was performed up to 4.2 V, whereupon a constant voltage charge operation was performed for 12 hours. Further, a constant current discharge operation was performed until the voltage reached a discharge termination voltage of 3.5 V. The capacity that was achieved by the initial discharge was determined to be the initial discharge capacity. A cycle of charging and discharging under the above conditions was repeated until the capacity was decreased to 70% or less of the initial discharge capacity, and the number of times the cycle was repeated was designated as a cycle characteristic. Also, a constant-current charge operation was performed with a current density of 1 mA/cm² up to 4.2 V, whereupon a constant-voltage charge operation was performed for 12 hours. Further, a constant-current discharge operation was performed until the voltage reached a discharge termination voltage of 3.5 V. The resulting capacity was compared with the initial cycle capacity obtained in the aforementioned charge/discharge cycle, and the ratio was designated as a high-speed charge/discharge characteristic. The results of evaluation of the initial discharge capacity, the cycle characteristics, and the high-speed charge/discharge characteristics are shown in Table 1.

[Evaluation of Interface Resistance]

The interface resistance was measured by an alternating current impedance method, wherein an alternating voltage of 10 mV is applied to between the electrodes of the battery prepared at 50° C. to measure the resistance component.

### EXAMPLE 2

A battery was prepared and evaluated in the same manner as in Example 1, except that polyvinylamine was used as a polycation instead of a polyaniline. The properties of the prepared battery are shown in Table 1.

### EXAMPLE 3

A battery was prepared and evaluated in the same manner as in Example 1, except that polyacrylic acid was used as a polyanion instead of polybutyl acrylate. The properties of the prepared battery are shown in Table 1.

### EXAMPLE 4

A battery was prepared and evaluated in the same manner as in Example 1, except that polyvinylamine was used as a polycation instead of a polyaniline and that polyacrylic acid was used as a polyanion instead of polybutyl acrylate. The properties of the prepared battery are shown in Table 1.

### COMPARATIVE EXAMPLE 1

A battery was prepared and evaluated in the same manner as in Example 1, except that the active materials were not coated with polymers. The properties of the prepared battery are shown in Table 1.

### COMPARATIVE EXAMPLE 2

A battery was prepared and evaluated in the same manner as in Example 1, except that polyethylene oxide was used instead of polyvinylamine and polybutyl acrylate. The properties of the prepared battery are shown in Table 1.

TABLE 1

| | | | High-speed | |
|---|---|---|---|---|
| | Initial | Cycle | charge/ | |
| | discharge | characteristics | discharge | Interface |
| | capacity | (number | characteristics | resistance |
| Example | (mAh) | of cycles) | (%) | (Ωcm²) |
| 1 | 1.7 | 150 | 60 | 60 |
| 2 | 1.7 | 200 | 70 | 70 |
| 3 | 1.7 | 250 | 80 | 80 |
| 4 | 1.7 | 280 | 85 | 85 |
| Comparative | 1.6 | 150 | 10 | 100 |
| Example 1 | | | | |
| Comparative | 1.6 | 160 | 40 | 400 |
| Example 2 | | | | |

Effects of the Invention

The present invention can provide electrochemical devices that realize easy formation of an electric double layer, i.e., a reaction field at the electrode interface, for the purpose of reducing interface resistance. According to the present invention, resistance at the active material/electrode interface can be reduced, and the internal resistance of a battery can be reduced. Thus, high-speed charge/discharge characteristics are particularly improved.

1. Electrochemical devices each independently having a positive electrode and a negative electrode, wherein the positive electrode and the negative electrode are each in contact with a polymer, and wherein the Lewis acid properties of a polymer that is in contact with the positive electrode are different from those of a polymer that is in contact with the negative electrode.

2. The electrochemical devices according to claim 1, wherein the positive electrode active material and the negative electrode active material are each in contact with the polymers.

3. The electrochemical devices according to claim 2, wherein the polymers having different Lewis acid properties are: a polycation, which is a polymer having a functional group that acts as a Lewis acid at a negative electrode; and a polyanion, which is a polymer having a functional group that acts as a Lewis base at a positive electrode.

4. The electrochemical devices according to claim 3, wherein the polyanion is a polymer having —COOR (R=H, an alkyl group) and/or —SO₃H and the polycation is a polymer having —NHR (R=H, an alkyl group).

5. Electrochemical devices each independently having a positive electrode and a negative electrode, wherein the surfaces of a positive electrode active material and of a negative electrode active material are coated with polymers, and the Lewis acid properties of the polymer that coats the positive electrode active material differ from those of the polymer that coats the negative electrode active material.

6. The electrochemical devices according to claim 5, wherein the polymer that coats the negative electrode active material is a polycation, which is a polymer having a functional group that acts as a Lewis acid, and the polymer that coats the positive electrode active material is a polyanion, which is a polymer having a functional group that acts as a Lewis base.

7. The electrochemical devices according to claim 6, wherein the polyanion is a polymer having —COOR (R=H, an alkyl group) and/or —SO₃H and the polycation is a polymer having —NHR (R=H, an alkyl group).
